(19) United States
(12) Patent Application Publication
(10) Pub. No.: US 2006/0229088 A1
(43) Pub. Date: Oct. 12, 2006

(54) Voice broadcast location system

(75) Inventor: Edward Walter, Boerne, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/103,944

(22) Filed: Apr. 12, 2005

(51) Int. Cl. H04Q 7/20

(52) U.S. Cl. 455/456.2

(57) ABSTRACT

A system and method is discussed for targeting a message to an intended listener over a public announcement system by selecting a single broadcast location, such as a speaker, from a plurality of broadcast locations. A typical method for locating a listener uses a method of triangulation of a wireless device located on the listener. A broadcast location is selected from distance calculations that determine which broadcast location is closest to the listener. Each broadcast location has an associated Internet Protocol (IP) address. The message is delivered to the IP address of the closest broadcast location. Voice over Internet Protocol (VoIP) technology can be used to selectively deliver the message.

### BACKGROUND OF THE INVENTION

1. Field of the Invention

The present invention provides a method and apparatus for targeting messages provided over public announcement systems. More particularly, the present invention provides a system for tracking an intended listener broadcasting a message from a broadcast location in a public announcement system selected for its proximity to the intended listener.

2. Description of the Related Art

Announcements made over public announcement (PA) systems are generally intended for an entire listening audience. Some announcements, however, are intended for a subset of the listening audience or even for an individual person. Currently, public announcement (PA) systems broadcast messages through connected speakers to a general audience regardless of the size or location of the intended audience. This can be especially annoying in instances where large groups of people are disrupted from their current activities to hear an announcement intended for only one person.

Recent advances in communications technologies have given rise to Voice over Internet Protocol (VoIP) in which a spoken message is transmitted from one telephonic device to another using technologies and methodologies developed for the Internet. In VoIP, an Internet Protocol (IP) address is assigned to a receiver so as to enable messages to get to an intended location. The possibility of extending VoIP technology to PA systems provides an opportunity to provide PA systems with extended capabilities.

### SUMMARY OF THE INVENTION

The present invention is a system and method for selecting a single broadcast location from a plurality of broadcast locations. An example of a broadcast location could be the location of a speaker electrically wired to a public announcement system. The location of a listener can be determined in relation to the plurality of broadcast locations using a suitable method of triangulation. In one embodiment, triangulation occurs using radio waves to determine a location of a wireless device located on the listener. A broadcast location is then selected based on the proximity of the broadcast location to the listener location. Each broadcast location has an associated coverage area over which a message broadcast from the broadcast location can be heard by a listener. The coverage area can be defined by a boundary zone, which is a contour of the coverage area. A boundary zone can be determined, for example, by having a technician test for acceptable listening distances from a broadcast location and recording representative locations along the boundary zone. The coordinates of these boundary zone locations can then be stored in a software database. Calculations can be made using the recorded coordinates to further define a software representation of the coverage area. When a listener location is found to be within the boundary zone, the corresponding broadcast location is selected. The broadcast signal is delivered to the selected broadcast location rather than to all broadcast locations. In an exemplary embodiment, each broadcast location has an associated Internet Protocol (IP) address. A broadcast signal is delivered to the appropriate IP address of the selected broadcast location by using Voice over Internet Protocol (VoIP) technology, for example.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 illustrates an exemplary short-range wireless network suitable for determining a listener location;

FIG. 2 depicts a set of broadcast locations that provide audio coverage over portions of a coverage area;

FIG. 3 illustrates an exemplary short-range wireless network for determining location;

FIG. 4 depicts an exemplary method for providing a boundary zone;

FIG. 5 depicts an exemplary system for determining a listener location;

FIG. 6 depicts an exemplary policy server;

FIG. 7 illustrates an implementation of the present invention in which broadcast locations are connected to a central hub; and

FIG. 8 depicts a flowchart illustrating a process of delivering a message to an intended listener in accordance with the present invention.

### DETAILED DESCRIPTION OF THE INVENTION

In view of the above, the present invention through one or more of its various aspects and/or embodiments is presented to provide one or more advantages, such as those noted below.

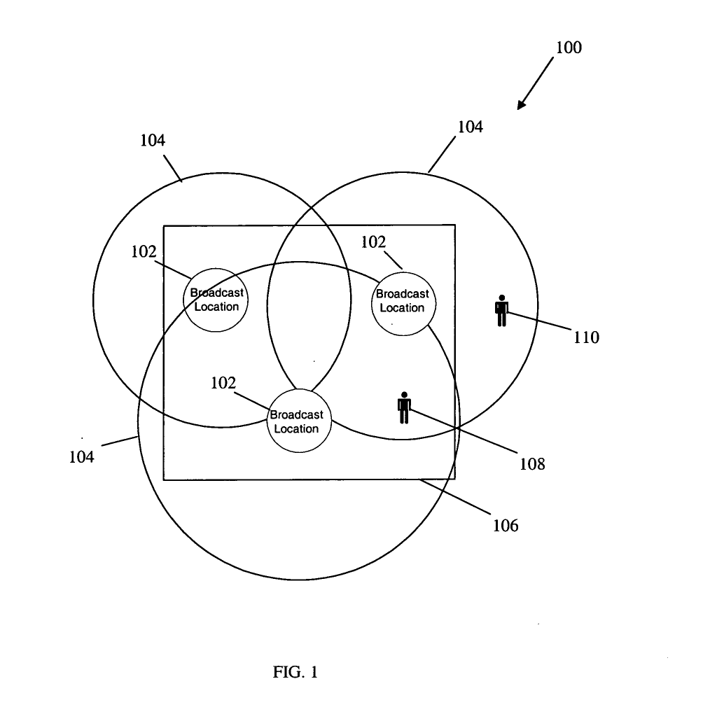

FIG. 1 illustrates an exemplary short-range wireless network suitable for determining a listener location. The exemplary short-range wireless network 100 includes a set of broadcast locations 102 that provides portions 104 of a coverage area. Typically, the coverage area portions 104 may extend beyond traditional physical boundaries or desired access areas. In this exemplary embodiment, the coverage area portions 104 extend beyond a physical boundary 106, such as a building, a room, an office space, a residence, or a shop location. In other examples, the boundaries or desired access areas 106 may include conceptual regions such as patios, balconies, reception areas, gardens, and parks.

The nature of the short-range wireless network is such that individuals having wireless enabled devices located within the portions 104 of the short-range wireless network coverage area may receive signals from one or more of the broadcast locations 102. An individual within a preferred access area, such as a listener 108, may receive data emitted by the broadcast locations 102. In addition, a user located outside the preferred access area, such as user 110, may also receive data transmitted from the broadcast locations 102.

Broadcast locations typically utilize a set of wireless transmitters having an effective range suitable to transmit a signal to a wireless receiver located near the plurality of broadcast locations. In exemplary embodiments, the broadcast locations 102 may provide a short-range wireless network using standards and protocols, such as Wi-Fi, Wi-Max, Institute of Electrical and Electronics Engineers (IEEE) 802.11x, IEEE 802.15, IEEE 802.16, and Bluetooth. A short-range wireless network may, for example, have an effective coverage area portion provided by an broadcast location, wherein the effective coverage area does not exceed 1000 feet in radius, such as not greater than 200 feet, or not greater than about 50 feet in radius. The short-range wireless network may, for example, provide wireless data network access in proximity to the broadcast locations, such as in and around a building, room, residence, office space, shop, or preferred access area. Wireless devices accessing the short-range wireless network may include wireless enabled computational devices, such as portable commuters, printers, handheld computational devices, portable digital assistants (PDAs), wireless data network enabled cellular telephones, and other networkable devices. In general, a short-range wireless network is not a cellular or pager based network and is an internet protocol (IP) based wireless data network. Alternately, long-range wireless networks can be used. Long-range wireless networks generally provide wireless networks having a radius greater than about 1000 feet. For example, long-range wireless networks include pager networks and cellular telephone networks, such as time division multiple access (TDMA), code division multiple access (CDMA), and global system for mobile communication (GSM) networks.

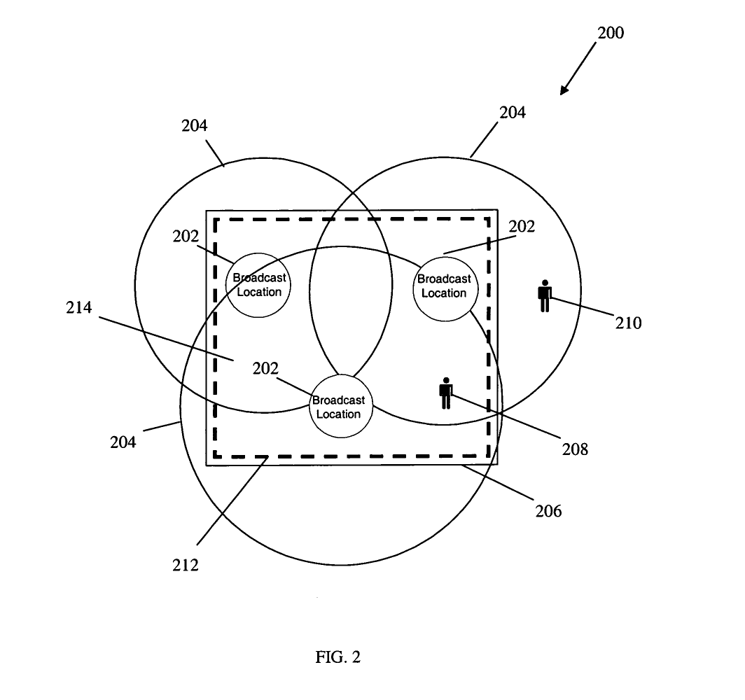

FIG. 2 depicts an exemplary short-range wireless network 200 that includes a set of broadcast locations 202 that each provide portions 204 of a wireless network coverage area. Listeners having wireless enabled devices such as listeners 208 and 210 may be located within the coverage area portions 204 and, as such, may receive network transmissions transmitted from broadcast locations 202. For example, a server or other network equipment may include boundary data that defines the boundary zone 214 and the boundaries 212. In this exemplary embodiment the boundary zone 214 corresponds closely with a preferred access area such as a room or building 206.

The location of a wireless enabled device and the listener carrying it may be determined using data from the broadcast locations. In one exemplary embodiment, a triangulation method uses at least three broadcast locations. For example, location may be determined by evaluating timing data associated with a signal reaching several broadcast locations. Network equipment such as a server or router device may include instructions for determining location based on timing data provided by the broadcast locations. In another exemplary embodiment, the triangulation method may use relative power levels of wireless communications received either at the wireless device or at the broadcast locations. The network equipment may determine the location relative to the broadcast locations based on these power measurements. In alternative embodiments, methods may be employed such as power measurement methods to determine location using one or two broadcast locations. A set of triangulated boundary points may be compared to locations of devices in the coverage area to determine whether the devices are located within a boundary zone.

The network equipment may use data from the broadcast locations 202 to determine whether wireless devices, such as those co-located with listeners 208 and 210 are located within the boundary zone 214. In one exemplary embodiment, the network equipment utilizes triangulation methods based on at least three broadcast locations 202 to determine the location of a listener and whether the listener is located within the boundary 212 or the boundary zone 214. Using this determination, the network equipment can select a broadcast location suitable for delivery of a message to the intended listener.

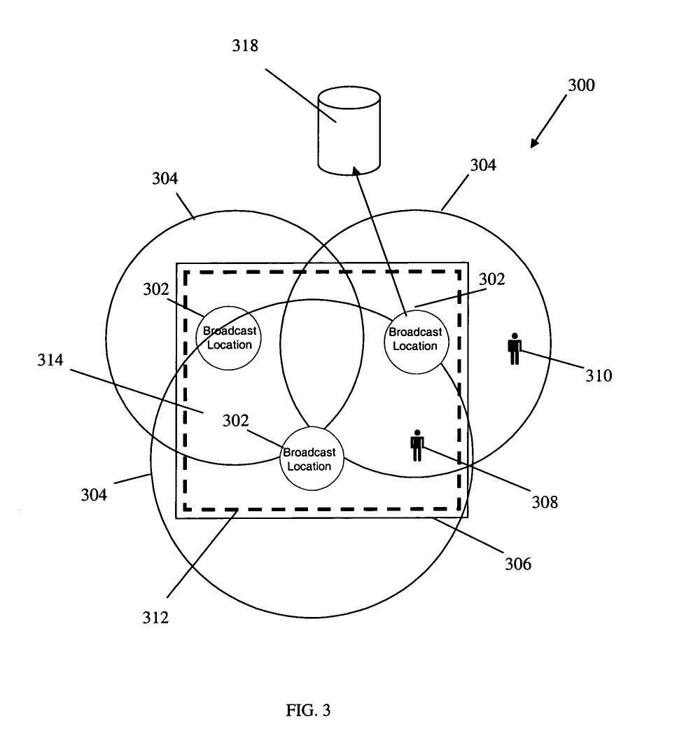

In one exemplary embodiment, the location of the intended listener with respect to the boundary zone can determine whether a message is delivered. FIG. 3 illustrates an exemplary short-range wireless network 300 that determines location. The short-range wireless network 300 may include wireless broadcast locations 302 that each cover a portion 304 of a coverage area. Within the coverage area, a boundary 312 may define a boundary zone 314 that represents an access area. In this exemplary embodiment, the access area and boundary zone 314 are located within a physical structure 306. For example, an access region may be located within a building, a room, a residence, an office space, a shop or a patio region. In this exemplary embodiment, wireless enabled devices located within the boundary zone 314, such as devices co-located with user 308 may indicate the accessibility of an intended listener. For example, the set of boundary locations 302 may provide data to network equipment, such as a server or router that determines the location of the listener will be able to hear a message and determines whether the user is within the boundary zone 314. Network packets provided to and received from the wireless device associated with the user 308 may be transmitted across the wireless network and may be given access to external wired networks. In contrast, wireless enabled devices located outside of the boundary zone 314, such as devices co-located with user 310, may indicate a listener is outside of a region for which a message can be delivered. For example, network equipment may determine the location of the user 310 based on data from a set of broadcast locations 302. Using this location determination, a message for the listener 310 may be dropped, discarded, or sent to a holding place or trash 318.

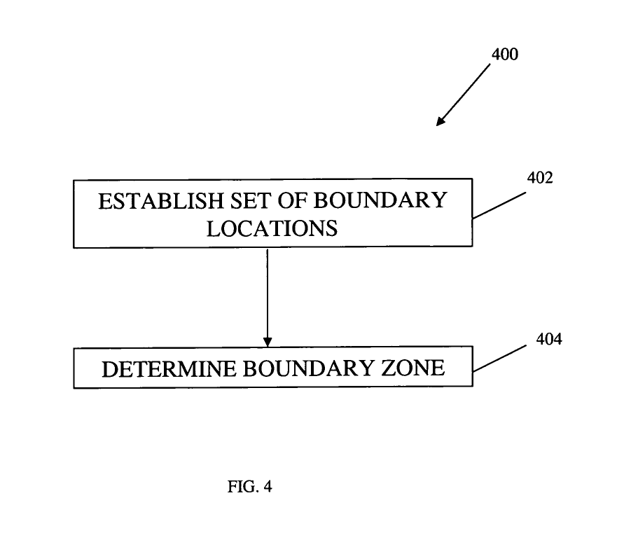

FIG. 4 depicts an exemplary method for providing a boundary zone. As shown at step 402, a set of boundary locations is established. For example, a wireless calibration device may communicate with network equipment to establish a set of locations along a boundary. The first step to “triangulation” on a target user is to establish a set of boundary location around the broadcast locations. The boundary can be established, for example, by taking discrete triangulation measurements while walking the contour of the area where a zone is to be established. To simplify the operation of establishing a zone, a Wi-Fi handheld device can be setup as the distant end unit to measure location in relation to the broadcast locations. For the purposes of triangulation while walking the boundary zone of the broadcast location, multiple (at least three) broadcast locations and a Boundary Zone Application enable building a software representation of the boundary zone. The Boundary Zone Application is a simple program that records measurements between broadcast location and Wi-Fi device to provide a location of the Wi-Fi device. This set of locations may be converted to boundary data that defines a boundary zone. In this manner, the boundary zone is determined, as shown at step 404. By placing enough points together, a curve can be established that effectively defines the boundary zone. Once this boundary zone has been established and set by the Boundary Zone Application, all future listener locations can be defined as being either inside or outside a boundary zone.

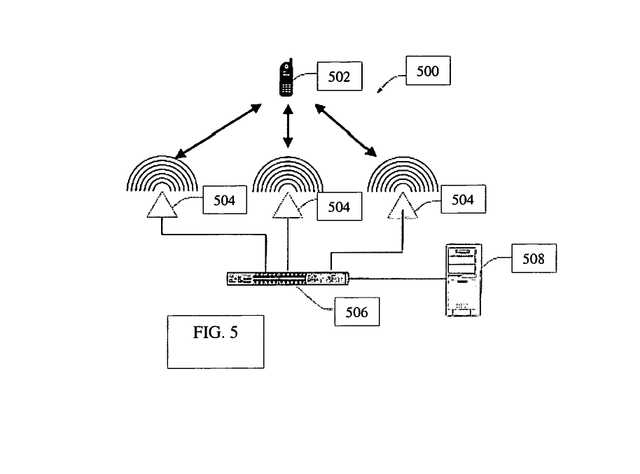

FIG. 5 depicts an exemplary system 500 for determining a listener location. A listener-carried device 504, such as a wireless hand-held electronic device, a wireless enabled laptop or a short-range wireless enabled cell phone, may interact with broadcast locations 504 when located within the coverage area of the short-range wireless network. Each broadcast location comprises a radio transmitter and receiver working typically within the 2.4 GHz frequency spectrum. When a Wi-Fi device first enters a Wi-Fi network it responds to a beacon request for response. The Wi-Fi device responds to all available broadcast locations within the wireless network. The difference in arrival times between the Wi-Fi device and at least three broadcast locations provides enough information to triangulate the location of the user. The wave propagation characteristics of radio waves from the radio transmitter travel at the speed of light. The speed of light is a calculation based upon distance and time and is a known value. An acceptable value for the speed of light in air is 299,702,547 meters per second. The time value is determined between multiple broadcast locations and the Wi-Fi device. The time value is calculated by differences in times between each broadcast location and the Wi-Fi device. The distances can thus be calculated from known value of the speed of light and time differences measured at the broadcast locations. The broadcast locations 504 collect data associated with the location of the wireless device 502 and transfer that data via a router or other network equipment 506 to a policy server 508. For example, the broadcast locations 504 may record a time that a signal was received. This signal arrival time may be transferred to the policy server 508 and the policy server 508 may determine the location of the wireless device within a coverage area based on the reported signal arrival times from each broadcast location 504. The policy server 508 compares the location with boundary zone data to determine whether the wireless device 502 is located within a boundary zone.

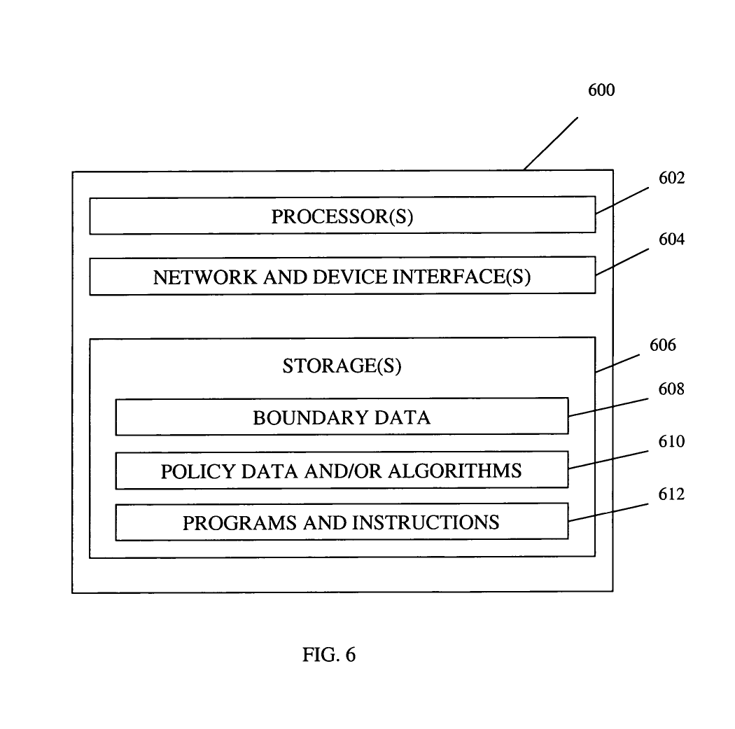

FIG. 6 depicts an exemplary policy server 600. The policy server 600 may be a separate computational system or may be implemented within other data network equipment. The policy server includes processors 602, network and device interfaces 604, and storage 606, such as memory. The storage or memory 606 includes boundary data 608 and programs and instructions 612, and may include policy data and/or algorithms 610.

The network and device interfaces 604 interact with the broadcast locations and with network equipment. For example, the network and device interfaces 604 include interfaces to broadcast locations that implement a wireless short-range wireless network and a PA speaker. Through this interaction with the broadcast locations, data associated with the location of a wireless device are transferred to the policy server 600.

Programs and instructions 612 are operable by the processors 602 to determine the location of the wireless device within the short-range wireless network coverage area based on the data received from the broadcast locations. For example, the programs and instructions 612 may include logic for determining location. In addition, the program and instructions 612 may also include software instructions for comparing the location of the wireless device to boundary data 608. From this comparison, the system determines whether particular wireless devices are located within or outside of a boundary zone.

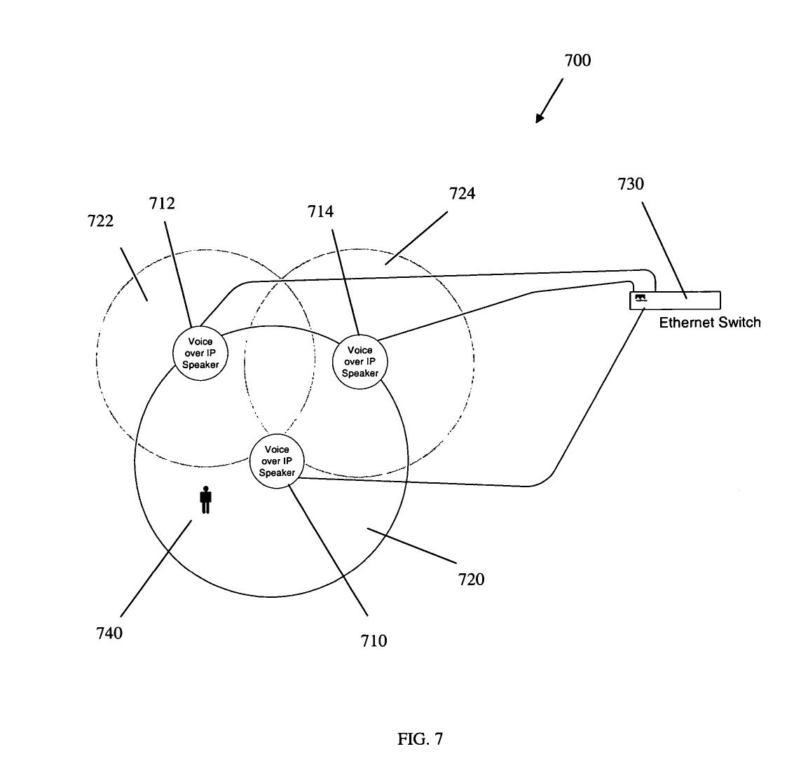

FIG. 7 illustrates an exemplary implementation 700 of the present invention in which broadcast locations 710, 712, and 714 are connected in a star configuration (e.g., parallel connection) to a central hub 730, such as an Ethernet switch. Other configurations for connecting broadcast locations are also possible for implementing the present invention. Broadcast locations 710, 712, and 714 cover corresponding boundary zones 720, 722, and 724, respectively.

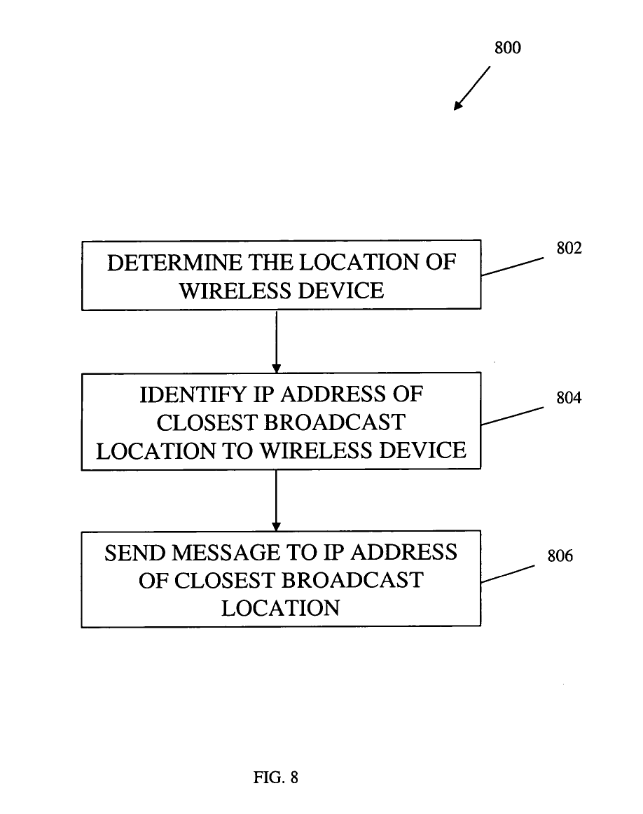

FIG. 8 illustrates a flowchart 800 for implementing the present invention and delivering a message to an intended listener. The present invention leverages the characteristics of an Ethernet Packet network. Each broadcast location is assigned a unique Internet Protocol (IP) address. The listener is located (Box 802) by triangulation methods for locating a wireless device carried by the listener. Upon determination of the listener location, the policy server determines the broadcast location most suitable for broadcasting a message to the listener by determining in which boundary zone the listener resides at the point of broadcast. The policy server then identifies the IP address of the closest broadcast location (Box 804). In accordance with the policy server, the Ethernet switch 730 then transfers the message to the appropriate broadcast location (Box 806). In an exemplary method message transfer, VoIP is used to deliver the message to the broadcast location. In the illustration of FIG. 7, the listener 740 is located within boundary zone 720, so the message would be delivered to broadcast location 710. An advantage of the present invention is that it provides “zoning” without re-engineering the speaker (PA system) cabling.

While the examples depict utilize a boundary that is determined based on data associated with a short-range network, a boundary zone may be determined using long-range networks and policies and features applied based on location within the long-range network. For example, location may be determined by GPS or cellular triangulation and policies applied to devices based on a policy mapping within the cellular network. Policies, such as the feature policy or network policy, may be implemented on a long-range network. In addition, IP-based communications protocols may be implemented that extend beyond the typical range of short-range wireless networks. In one exemplary embodiment, a Wi-Max or IEEE 802.16 network that has a long-range coverage area may be used to implement boundary zones.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Further, the system of the present invention provides a substantially online, real time system for managing attendance throughout an organization, wherein attendance-related data may be entered at various locations and through various input devices, some of which may be entered in real time and may include exception time reporting. The system further provides selected attendance reports to employees, supervisors and management personal in real time through an intracompany server and/or via the Internet.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for selecting a single broadcast location for a broadcast signal, comprising:
i) determining a location of a listener relative to a plurality of broadcast locations; and
ii) selecting from the plurality of broadcast locations, a broadcast location closest to the listener location from the plurality of broadcast locations; and
iii) delivering the broadcast signal to the selected broadcast location.

2. The method of claim 1, wherein determining the listener location further comprises using a method of triangulation.

3. The method of claim 2, wherein the method of triangulation uses a determination of a location of a wireless device.

4. The method of claim 1, wherein selecting a broadcast location further comprises determining proximity of the listener location to the broadcast location.

5. The method of claim 4, wherein determining proximity of the listener location further comprises determining a boundary zone for a broadcast location.

6. The method of claim 5, wherein determining a boundary zone further comprises storing a set of zone locations obtained at physical locations in a software database.

7. The method of claim 1, wherein delivering the broadcast signal further comprises i) associating Internet Protocol (IP) addresses to the plurality of broadcast locations, and, ii) delivering broadcast content from a source to the IP address associated with the selected broadcast location.

8. The method of claim 7, wherein the encoded message is transmitted using Voice over Internet Protocol.

9. A computer readable medium containing instructions that when executed by a computer enable the computer to perform a method for selecting from the plurality of broadcast locations, a single broadcast location for a broadcast signal, comprising:
i) determining a location of a listener relative to a plurality of broadcast locations; and
ii) selecting a broadcast location closest to the listener location from the plurality of broadcast locations; and
iv) delivering the broadcast signal to the selected broadcast location.

10. The medium of claim 9, wherein in the method determining the listener location further comprises using a method of triangulation.

11. The medium of claim 10, wherein in the method the triangulation uses a determination of a location of a wireless device.

12. The medium of claim 9, wherein in the method selecting a broadcast location further comprises determining a proximity of the listener location to the broadcast location.

13. The medium of claim 12, wherein in the method determining proximity of the listener location further comprises determining a boundary zone for a broadcast location.

14. The method of claim 13, wherein in the method determining a boundary zone further comprises storing a set of zone locations obtained at physical locations in a software database.

15. The medium of claim 9, wherein in the method delivering the broadcast signal further comprises i) associating Internet Protocol (IP) addresses to the plurality of broadcast locations, and, ii) delivering broadcast content from a source to the IP address associated with the selected broadcast location.

16. The medium of claim 15, wherein in the method the encoded message is transmitted using Voice over Internet Protocol.

17. A apparatus for selecting a single broadcast location, comprising:
i) a plurality of broadcast locations; and
ii) a process that determines a location of a listener relative to the plurality of broadcast locations and selects from the plurality of broadcast locations, a broadcast location closest to the listener location from the plurality of broadcast locations and delivers the broadcast signal to the selected broadcast location.

18. The apparatus of claim 17, wherein the processor determines the listener location uses triangulation.

19. The apparatus of claim 18, wherein the process uses triangulation to determine a location of a wireless device.

20. The apparatus of claim 17, wherein the processor selects a broadcast location by determining a proximity of the listener location to the broadcast location.

21. The apparatus of claim 20, wherein the processor determines proximity of the listener location by determining a boundary zone for a broadcast location.

22. The apparatus of claim 21, wherein the processor determines a boundary zone by storing a set of zone locations obtained at physical locations in a software database.

23. The apparatus of claim 16, wherein delivering the broadcast signal further comprises i) associating Internet Protocol (IP) addresses to the plurality of broadcast locations, and, ii) delivering broadcast content from a source to the IP address associated with the selected broadcast location.

24. The apparatus of claim 23, wherein the encoded message is transmitted using Voice over Internet Protocol.
